(19) United States
(12) Patent Application Publication
(10) Pub. No.: US 2012/0100813 A1
(43) Pub. Date: Apr. 26, 2012

(54) SYSTEM FOR TESTING MULTI-ANTENNA DEVICES USING BIDIRECTIONAL FADED CHANNELS

(76) Inventors: Matt A. Mow, Los Altos, CA (US); Robert W. Schlub, Cupertino, CA (US); Rocco V. Dragone, JR., Mountain View, CA (US); Ruben Caballero, San Jose, CA (US); Thomas E. Biedka, San Jose, CA (US)

(21) Appl. No.: 13/052,381

(22) Filed: Mar. 21, 2011

Related U.S. Application Data
(63) Continuation-in-part of application No. 12/946,772, filed on Nov. 15, 2010.
(60) Provisional application No. 61/405,105, filed on Oct. 20, 2010.

(51) Int. Cl. H04B 17/00

(52) U.S. Cl. 455/67.12

(57) ABSTRACT

A test system for testing multiple-input and multiple-output (MIMO) systems is provided. The test system may convey radio-frequency (RF) signals bidirectionally between a device under test (DUT) and at least one base station. The DUT may be placed within a test chamber during testing. An antenna mounting structure may surround the DUT. Multiple antennas may be mounted on the antenna mounting structure to transmit and receive RF signals to and from the DUT. A first group of dual-polarized antennas may be coupled to the base station through downlink circuitry. A second group of dual-polarized antennas may be coupled to the base station through uplink circuitry. The uplink and downlink circuitry may each include a splitter/combiner, channel emulators, amplifier circuits, and switch circuitry. The channel emulators and amplifier circuits may be configured to provide desired path loss, spatial interference, and channel characteristics to model real-world wireless network transmission.

This application is a continuation-in-part of U.S. application Ser. No. 12/946,772, filed Nov. 15, 2010, which is hereby incorporated by reference herein in its entirety, and which claims the benefit of provisional patent application No. 61/405,105, filed Oct. 20, 2010, which is hereby incorporated by reference herein in its entirety.

### BACKGROUND

This relates to testing devices with antennas, and more particularly, to testing multi-antenna devices.

Electronic devices such as handheld electronic devices, portable electronic devices, and computers often have wireless communication capabilities. Electronic devices with wireless communication capabilities typically include antennas. Antennas transmit and receive radio frequency (RF) signals.

It may be desirable to incorporate more than one antenna in a single electronic device. Electronic devices with more than one antenna may sometimes be referred to as multi-antenna devices. Multi-antenna devices may exhibit improved performance over single-antenna devices. The performance improvement provided by multi-antenna devices may depend on factors such as multipath propagation, spatial correlation of the wireless signals, delay/frequency spread of the wireless signals, etc. It may be desirable to optimize multi-antenna devices while taking into account the various factors that affect device performance.

In order to optimize the design of multi-antenna devices, it may be useful to test a wireless communications system in which data is sent back and forth between a first device and a second device. The first and second devices may each have more than one antenna. Wireless signals that travel back and forth between the first and second devices may travel through a channel whose properties are affected by the presence of obstacles, reflective materials, and other environmental factors.

For example, imagine a scenario in which a cellular telephone is communicating wirelessly with a base station. The wireless communications channel in this type of scenario will be influenced by physical variations in terrain between the cellular telephone and the cell tower such as the presence of buildings, moving cars, mountains, regions of water, etc.

Efforts have been made to simulate communications systems using software. In software simulations, the behavior of communications devices and the wireless channel are handled using software abstractions. Software simulations are not necessarily accurate models of the actual characteristics of a channel and the interactions between the communicating devices and the channel.

To address the shortcomings of software simulations, efforts have also been made to simulate a communications system using channel emulator hardware. In a typical test arrangement, a first device may have a first RF front end disconnected from the antenna of the first device. The first RF front end may be connected to an input of a channel emulator. A second device may have a second RF front end that is disconnected from the antenna of the second device. The second RF front end may be connected to an output of the channel emulator. The channel emulator attempts to recreate the characteristics of a real-life channel (e.g., multipath gain, multipath delay, etc.). Because the channel emulator makes simplifying assumptions about the behavior of a typical channel, the channel emulator will not be able to effectively model how the antennas behave within the device housing, how polarization and gain effects impact antenna performance, or how devices with multiple antennas operate.

Moreover, conventional test arrangements that are used for testing MIMO systems do not accurately emulate uplink channel fading and uplink path loss. The conventional test systems use uplink path loss values that are different than the path loss values experienced by radio-frequency signals in realistic wireless networks. The uplink signal path of conventional test systems typically remains unperturbed by any form of fading and sees low levels of attenuation. Testing multi-antenna devices in this way may not be capable of accurately characterizing uplink performance.

It would therefore be desirable to be able to provide improved ways to test wireless communications performance for devices with antennas.

### SUMMARY

A test system is provided for wireless testing of electronic devices. The electronic devices may have multiple antennas. A multi-antenna device that is being tested may be referred to as a device under test (DUT).

At least one DUT may be placed within a test chamber during wireless testing. The walls of the test chamber may be lined with radio-frequency (RF) absorbent material (e.g., a rubberized pyramid-shaped foam) that minimizes reflections of wireless signals.

An antenna mounting structure may surround the DUT in the test chamber. The antenna mounting structure may have first and second portions. Test antennas (sometimes referred to as over-the-air antennas) may be mounted on the antenna mounting structure in a desired array pattern. For example, the array pattern may be a substantially two-dimensional pattern (e.g., a ring-shaped arrangement) that surrounds the DUT in two dimensions or a three-dimensional pattern (e.g., a spherical arrangement) that surrounds the DUT in three dimensions.

The test antennas may include a first group of dual-polarized antennas that are used for downlink transmission (e.g., antennas that transmit RF signals to the DUT). The first group of antennas may be attached to the first antenna mounting portion and may generate a desired feasibility region in which the DUT is tested. The feasibility region represents the portion of the testing chamber that has a desired radiation pattern. The first group of antennas (e.g., downlink test antennas) may be coupled to a base station emulator through downlink circuitry. The downlink circuitry may include a first radio-frequency splitter, first channel emulators, and first amplifier circuits.

The test antennas may include second group of antennas that are used for uplink testing (e.g., antennas that receive RF signals from the DUT). These test antennas may be placed in desired locations on the second antenna mounting portion to provide the desired spatial fading. The second group of antennas (e.g., uplink test antennas) may be coupled to the base station emulator through uplink circuitry. Uplink circuitry may include a second radio-frequency splitter, second channel emulators, and second amplifier circuits.

A test system of this type may support bidirectional multiple-input and multiple-output (MIMO) wireless testing. The test system can be used to accurately test wireless performance in the presence of effects such as multipath propagation, interference, handover mechanisms, power control, delay and frequency spread of wireless signals, etc. The test system may accurately emulate uplink and downlink path loss (e.g., by using amplifiers and attenuators to provide predetermined downlink and uplink path loss) and channel characteristics to model real-world wireless transmission between base stations and wireless electronic devices (e.g., the test system may accurately emulate fading downlink channels and fading uplink channels).

The test system may be used to test a variety of operating scenarios. The test system may, for example, be used in testing various types of cellular networks, wireless local area networks (WLAN), communications systems that use various modulation and multiplexing techniques (e.g., frequency-division duplexing, time-division-multiplexing, etc.), other system configurations (e.g., multiple-input-multiple-output (MIMO) configurations, single-input-multiple-output (SIMO) configurations, multiple-input and single-output (MISO) configurations, and single-input-single-output (SISO) configurations, etc.). Tests may also be performed on configurations that include multiple access points, multiple DUTs, etc.

Further features of the present invention, its nature and various advantages will be more apparent from the accompanying drawings and the following detailed description.

### BRIEF DESCRIPTION OF THE DRAWINGS

FIG. 1 is a diagram showing an illustrative multi-antenna device that may be used as a device under test when performing wireless testing in a test system in accordance with an embodiment of the present invention.

FIG. 2 is a diagram showing an illustrative system that can be used for bidirectional testing of wireless equipment such as multi-antenna devices in accordance with an embodiment of the present invention.

FIG. 3 is a diagram of an illustrative downlink channel emulator in accordance with an embodiment of the present invention.

FIG. 4 is a diagram of an illustrative uplink channel emulator in accordance with an embodiment of the present invention.

FIG. 5 is a diagram of illustrative test equipment with a directional coupler in accordance with an embodiment of the present invention.

FIG. 6 is a diagram of illustrative test equipment with a duplexer in accordance with an embodiment of the present invention.

FIG. 7 is a diagram of an illustrative test setup using fiber optic cabling for uplink testing in accordance with an embodiment of the present invention.

FIG. 8 is a diagram of an illustrative test setup using fiber optic cabling for downlink testing in accordance with an embodiment of the present invention.

FIG. 9 is a diagram showing an illustrative spherical antenna array structure in a test chamber in accordance with an embodiment of the present invention.

FIG. 10 is a diagram of an illustrative system in which multiple base stations are used for bidirectional wireless testing in accordance with an embodiment of the present invention.

FIG. 11 is a diagram of an illustrative system in which multi-stream radio-frequency signals are conveyed between multiple base stations and a device under test in accordance with an embodiment of the present invention.

FIG. 12 is a diagram of an illustrative system configurable to perform bidirectional wireless testing in different radio-frequency bands in accordance with an embodiment of the present invention.

FIG. 13 is a diagram of an illustrative system configurable to perform bidirectional wireless and conducted testing in accordance with an embodiment of the present invention.

FIG. 14 is a diagram showing how downlink radio-frequency signals may interfere with uplink signal reception in accordance with an embodiment of the present invention.

FIG. 15 is a plot illustrating how downlink interference signals may be filtered in accordance with an embodiment of the present invention.

FIG. 16 is a plot illustrating how downlink signals may be shifted in frequency so that downlink spurs and noise do not interfere with uplink signal reception in accordance with an embodiment of the present invention.

FIG. 17 is a diagram of illustrative multi-band isolation circuitry in accordance with an embodiment of the present invention.

### DETAILED DESCRIPTION

This relates to test systems for wireless testing of electronic equipment. The test systems may, for example, be used to test electronic devices with multiple antennas.

Electronic devices such as handheld electronic devices, portable electronic devices, computers, and other multimedia electronic devices may include antennas such as patch antennas, planar inverted-F antennas, slot antennas, etc. To enhance wireless performance, it may be desirable for a device to use multiple antennas. By using multiple antennas simultaneously, capacity can be enhanced.

Such multiple-antenna equipment can, however, pose testing challenges. Multiple antenna systems typically operate by exploiting the multiple paths between transmitters and receivers. These multiple paths may, for example, involve radio-frequency signals that are received at a device from widely divergent angles. Some paths may, for example, involve almost direct, line-of-sight communications between transmitter and receiver. Other paths may involve reflections off of intervening objects and may arrive at a receiver from a much different angle. To properly test a device that has multiple antennas, it may therefore be desirable to use the test system to replicate complex three-dimensional operating environments. For example, it may be desirable to use the test system to create radio-frequency signal beams that can be directed at a device under test from a desired arbitrary angle or combination of angles in three-dimensional space.

Antennas are components that are designed to transmit or receive electromagnetic waves such as radio frequency (RF) waves. Electronic devices with antennas may transmit or receive RF signals wirelessly.

A single electronic device such as a portable handheld electronic device may have more than one antenna. A multi-antenna device may exhibit performance improvements over a single-antenna device. For example, in comparison to a single-antenna device, a multi-antenna device may have a higher antenna gain and/or increased capacity. It may therefore be desirable to use multi-antenna devices in a communications system. A communications system in which multiple antennas are used at both the transmitting device and the receiving device may sometimes be referred to as a multiple-input and multiple-output (MIMO) system or a multiple antenna system (MAS).

It may be desirable to optimize a multi-antenna device for use in a MIMO system. Consider a first (simplified) scenario in which a first single-antenna device is communicating wirelessly with a second single-antenna device. The first single-antenna device may be a user's cellular telephone. The second single-antenna device may be a cellular telephone base station. The first single-antenna device may attempt to transmit a packet of data to the second single-antenna device. The transmitted data may be in the form of wireless signals (e.g., RF signals). The wireless signals may travel through air. The wireless signals may also make contact with intervening objects that exist between the first and second single-antenna devices. The wireless signals may therefore be deflected or reflected off the surfaces of the intervening objects. The intervening objects may include buildings, moving cars, bodies of water, mountains, the ionosphere, animals, or any other entity that may exist between the first and second single-antenna devices.

In a typical scenario, the wireless signals that are transmitted by the cellular telephone will not all take the same path to the cellular base station. For example, the wireless signals may each be deflected or reflected off the surfaces of different intervening objects at different angles. Different portions of the wireless signals may therefore reach the receiving antenna through different paths. The phenomenon in which radio signals arrive at a receiving antenna over two or more distinct paths is sometimes referred to as multipath propagation.

The collective medium through which the wireless signals may travel between the two wireless devices may be referred to as the channel of the wireless communications system. Accurate modeling of a wireless communications channel in an environment where multipath propagation is present can be fairly complex, because the channel is a time-dependent entity (e.g., the characteristic of the channel may constantly be evolving in time) and should take into account all possible intervening objects and different possible paths that may be taken by the wireless signals. Despite these difficulties, software simulations and channel emulation hardware can often be used to satisfactorily test single-antenna equipment if appropriate simplifying assumptions are made.

Wireless tests on multi-antenna equipment cannot, however, always be tested using conventional test systems. Consider, as an example, a second scenario in which a first multi-antenna device is communicating with a second multi-antenna device (i.e., MIMO system). The wireless signals transmitted in the second scenario may likewise be sent through a channel. This second scenario will generally be much more complex than the first scenario because the behavior of each of the multiple antennas may interact and interfere with one another. Wireless tests performed on the first and second antennas in isolation cannot simply be superimposed to determine the wireless performance of the antennas when operating together. This is because the behavior of one antenna on a receiving device will typically affect the behavior of another antenna on the receiving device. It is therefore difficult or impossible to realistically simulate a MIMO scenario exclusively in software.

It may therefore be desirable to test the MIMO configuration using an approach that utilizes actual hardware. Conventional hardware testing involves connecting a base station to a test device through a channel emulator. The channel emulator is a type of “black box” that can emulate the behavior of a real-life channel. The base station and the test device may each have an RF front end and an antenna. The RF front end of the base station is directly routed to the channel emulator. The RF front end of the test device is directly connected to the channel emulator. The antennas of the base station and/or the test device are effectively decoupled from the test system, because the antennas are not connected to the RF front ends and are not involved in transmission or retrieval of the wireless signals. Testing a wireless communications system in this way may not fully take into account the interaction of the antennas with the channel, the interaction of the antennas with other components in the wireless device, the interference and noise associated with the multiple antennas, etc.

A controlled test environment that can accurately emulate actual wireless communication (e.g., in a MIMO system) and that can take into account the behavior of the multiple antennas may be used to enhance test performance. A device under test (DUT) may be placed in the controlled test environment. The DUT may be a multi-antenna device. The antenna design of the DUT may be varied to explore the impact of design variations. For example, the number of antennas, the distance between antennas, the orientation of the antennas, and the polarization of the antennas may be adjusted. Tests can be performed for each test configuration. Each of the multiple antennas in the tested equipment may be active, allowing protocol-compliant tests to be performed. Using this approach, an antenna designer can investigate the effects/tradeoffs of such adjustments to produce an optimized antenna design for a wireless communications system.

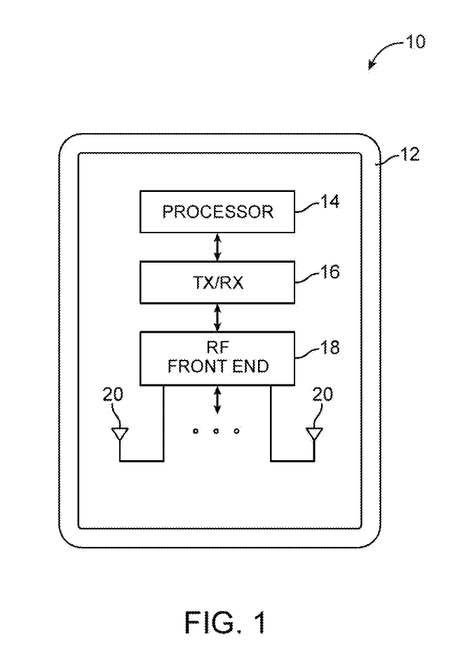

FIG. 1 shows an example of a test device such as device under test (DUT) 10. DUT 10 may be a handheld electronic device, a portable electronic device, a computer, a multimedia device, or any other electronic equipment. DUT 10 may have a device housing such as housing 12 that forms a case for its associating components.

DUT 10 may have a processor such as processor 14. Processor 14 may be used in controlling the operation of DUT 10. Processor 14 may include one or more processing circuits. Examples of circuits that may be used in implementing processor 14 include microprocessors, baseband processors, digital signal processors, microcontrollers, application-specific integrated circuits, etc.

Processor 14 may interact with a transceiver circuit such as transceiver block 16. Transceiver block 16 may include an analog-to-digital converter (ADC), a digital-to-analog converter (DAC), a digital down converter (DDC), and a digital up converter (DUC). In a scenario in which DUT 10 is transmitting, processor 14 may provide digital data (e.g., baseband signals) to the DUC. The DUC may convert or modulate the baseband digital signals to an intermediate frequency (IF). The IF digital signals may be fed to the DAC to convert the IF digital signals to IF analog signals. The IF analog signals may then be fed to an RF front end such as RF front end 18.

In another scenario in which DUT 10 is receiving wireless signals, RF front end 18 may provide incoming IF analog signals to the ADC. The ADC may convert the incoming IF analog signals to incoming IF digital signals. The incoming IF digital signals may then be fed to the DDC. The DDC may convert the incoming IF digital signals to incoming baseband digital signals. The incoming baseband digital signals may then be provided to processor 14 for further processing. Transceiver block 16 may either up-convert baseband signals to IF signals or down-convert IF signals to baseband signals. Transceiver block 16 may therefore sometimes be referred to as an IF stage.

RF front end 18 may include circuitry that couples transceiver block 16 to device antennas such as antennas 20. RF front end 18 may include circuitry such as matching circuits, band-pass filters, mixers, a low noise amplifier (LNA), a power amplifier (PA), etc. In the scenario in which DUT 10 is transmitting, RF front end 18 may up-convert the IF analog signals from transceiver block 16 to RF analog signals (e.g., the RF signals typically have higher frequencies than the IF signals). The RF analog signals may be fed to antennas 20 and may be broadcasted.

In the other scenario in which DUT 10 is receiving wireless signals, antennas 20 may receive incoming RF analog signals from a broadcasting device such as a base transceiver station, access point, etc. The incoming RF analog signals may be fed to RF front end 18. RF front end 18 may down-convert the incoming RF analog signals to IF analog signals. The IF analog signals may then be fed to transceiver block 16 for further data processing.

Processor 14, transceiver block 16, RF front end 18, and antennas 20 may be housed within housing 12. As shown in FIG. 1, there may be more than one antenna 20 within housing 12. The number, position, orientation, polarization, and gain of the antennas may be adjusted for optimal performance of DUT 10 in a MIMO test system.

DUT 10 may include satellite navigation system receiver circuitry such as Global Positioning System (GPS) receiver circuitry (e.g., circuitry for receiving satellite positioning signals at 1575 MHz). Transceiver circuitry 16 may handle 2.4 GHz and 5 GHz bands for WiFi® (IEEE 802.11) communications and may handle the 2.4 GHz Bluetooth® communications band. DUT 10 may use cellular telephone transceiver circuitry for handling wireless communications in cellular telephone bands such as bands at 850 MHz, 900 MHz, 1800 MHz, 1900 MHz, and 2100 MHz or other cellular telephone bands of interest. DUT 10 may include circuitry for other short-range and long-range wireless links if desired. For example, DUT 10 may include wireless circuitry for receiving radio and television signals, paging circuits, etc. In WiFi® and Bluetooth® links and other short-range wireless links, wireless signals are typically used to convey data over tens or hundreds of feet. In cellular telephone links and other long-range links, wireless signals are typically used to convey data over thousands of feet or miles.

During wireless testing, DUT 10 may be configured to transmit multiple data streams. For example, the GPS receiver circuitry may transmit a first signal stream using a first set of antenna(s), whereas the cellular telephone transceiver circuitry may transmit a second signal stream using a second set of antenna(s). If desired, DUT 10 may be configured to generate any number of independent data streams using any number of antennas.

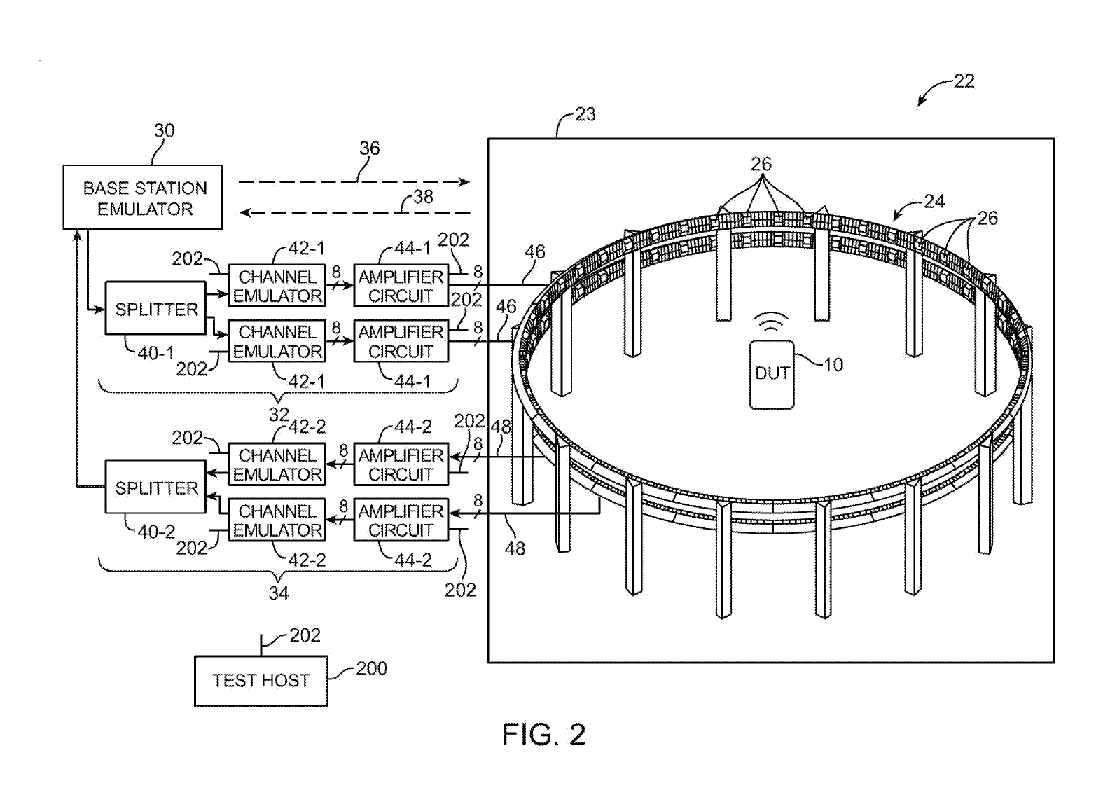

An illustrative test system that may include a two-dimensional array of test antennas is shown in FIG. 2. Test system 22 of FIG. 2 may be used to model wireless communication between DUT 10 and a base transceiver station in a MIMO system. Test system 22 may be configured to accurately model downlink and uplink radio-frequency signal paths in “live” wireless networks (e.g., test system 22 may be configured to provide predetermined downlink path loss and uplink path loss that track path loss experienced by radio-frequency signals in real-world environments). Test system 22 can also be used to model spatial fading (e.g., random deviations in signal power attenuation over a given propagation medium) associated with the downlink path and the uplink path.

Comprehensive testing may require the ability to operate all of the antennas in DUT 10 while using test system 22 to produce radio-frequency test signals with a wide range of possible orientation angles, beam divergences, etc. To ensure that these tests are exhaustive, it may be desirable to use a two-dimensional or three-dimensional array of antennas in a test chamber. A two-dimensional array of test antennas can be used in the test system to recreate test signals that approach the DUT from any desired angle in a horizontal test plane (i.e., at any angle from 0-360°, whereas a three-dimensional antenna array can be used to sweep the test beam out of the horizontal plane.

As shown in FIG. 2, test system 22 may include an antenna mounting structure such as antenna mounting structure 24, a base station emulator such as base station emulator 30, circuitry 32 that is associated with downlink testing, circuitry 34 that is associated with uplink testing, and other control circuitry and test equipment. Antennas such as antennas 26 (sometimes referred to as over-the-air antennas) may be mounted on antenna mounting structure 24 in an arrangement as shown in FIG. 2.

Antenna mounting structure 24 may be placed in a test chamber such as test chamber 23. Test chamber 23 may have a cubic structure (six square walls) or a rectangular prism-like structure (six rectangular walls), if desired. Test chamber 23 may be internally lined by absorbent material. The absorbent material may be formed from pyramid-shaped foams or other suitably lossy material. Test chamber 23 may sometimes be referred to as an anechoic chamber. If desired, reverberation chambers (e.g., chambers with one or more tuners that can be moved to different orientations to obtain varying spatial distribution of electrical and magnetic field strength) may also be used. If desired, multiple DUTs may be placed within chamber 23 to characterize multiple DUTs in parallel.

If desired, DUT 10 may be directly coupled to circuitry 34 using directional couplers and RF-to-optical fiber transceivers to sample transmissions from DUT 10 with minimal impact to device radiated performance.

Downlink circuitry 32 may serve to convey radio-frequency (RF) signals from base station emulator 30 to antennas 26 in the direction indicated by arrow 36. Downlink circuitry 32 may include radio-frequency splitter 40-1, channel emulators 42-1, and amplifier circuits 44-1. During wireless testing, base station emulator 30 may convey radio-frequency signals to splitter 40-1. Splitter 40-1 may couple the radio-frequency signals onto multiple paths.

Channel emulators 42-1 may each receive radio-frequency signals over a respective path from splitter 40-1. First channel emulator 42-1 may serve to emulate downlink signal paths for vertically polarized RF signals, whereas second channel emulator 42-1 may serve to emulate downlink signal paths for horizontally polarized RF signals (as an example). Antennas 26 (e.g., dual-polarized antennas) that are associated with downlink circuitry 32 (e.g., antennas 26 that are coupled to paths 46) may receive vertically polarized and horizontally polarized radio-frequency signals from channel emulators 42-1 through amplifier circuits 44-1.

Uplink circuitry 34 may serve to convey radio-frequency signals from antennas 26 to base station emulator 30 in the direction indicated by arrow 38. Uplink circuitry 34 may include radio-frequency splitter 40-2, channel emulators 42-2, and amplifier circuits 44-2. During wireless testing, antennas 26 that are associated with uplink circuitry 34 (e.g., antennas 26 that are coupled to paths 48) may convey radio-frequency signals received from DUT 10 to amplifier circuits 44-2. For example, a first group of uplink antennas 26 may be used to receive vertically polarized RF signals, where a second ground of uplink antennas 26 may be used to receive horizontally polarized RF signals. Amplifier circuits 44-2 may feed the vertically polarized and horizontally polarized radio-frequency signals to respective channel emulators 42-2. Splitter 40-2 may receive the radio-frequency signals from channel emulators 42-2. Splitter 40-2 may convey the radio-frequency signals to base station emulator 30.

Amplifier circuits 44-1 (e.g., low noise amplifiers, power amplifiers, power attenuators, etc.) may be configured to provide appropriate amplification/attenuation such that the downlink signals experience an appropriate amount of downlink path loss. Amplifier circuits 44-2 (which may include attenuator circuits) may be configured to provide appropriate amplification/attenuation such that uplink signals experience a desired amount of uplink path loss.

Accurately modeling downlink and uplink path loss using this approach enables accurate characterization of open-loop power control algorithms (e.g., algorithms that direct the DUT to transmit at a maximum output power level) and closed-loop power control algorithms (e.g., algorithms in which the base station emulator directs the DUT to adjust its output power level using transmit power control commands).

Amplifier circuits 44-1 and 44-2 may have control inputs that receive control signals from a test host such as test host 200 over control path 202. Test host 200 may, for example, be a host personal computer or other types of computing equipment. The control signals may be adjusted to the tune the gain/attenuation provided by each amplifier circuit. Adjustable amplifier circuits 44-1 and 44-2 may be configured to compensate for the wide dynamic range of signal power levels and pattern variations of DUT 10 (e.g., circuits 44-1 and 44-2 may be applied to uplink and downlink signal paths to equalize power levels transmitted and received at each antenna 26) and may therefore sometimes be referred to as automatic gain compensation (AGC) circuits.

Test host 200 may also control channel emulators 42-1 and 42-2 by sending command signals over path 202 (see, e.g., FIG. 2). For example, test host 200 may configure channel emulators 42-1 and 42-2 to perform channel emulation based on a selected channel model, to provide desired channel fading characteristics, etc.

Test system 22 may be characterized and calibrated for different scenarios. During downlink testing, a selected subgroup of antennas 26 may be used to transmit a desired pattern of radio-frequency signals to DUT 10 to model a first scenario (as an example). During uplink testing, DUT 10 may be directed to transmit RF signals in a desired direction to model a second scenario.

Test system 22 as shown in FIG. 2 is merely illustrative. Additional base station emulators may be used to add downlink signals via independently controlled spatial (downlink) fading channels and to model adjacent channel interference, handover scenarios, etc. Testing may be extended to real base stations (i.e., base station emulators 30 may be real base transceiver stations or cell towers), if desired. Testing performed using base station emulators 30 or real base stations may be used to test any wireless network technology (e.g., NodeB, eNobeB, access point, etc.).

Additional DUTs 10 may be placed within test structure 24 in a conducted or radiated arrangement to model uplink interference from same or adjacent channels. Each path (e.g., path 46 or path 48) may be coupled to less than eight antennas 26 or more than eight antennas 26, if desired.

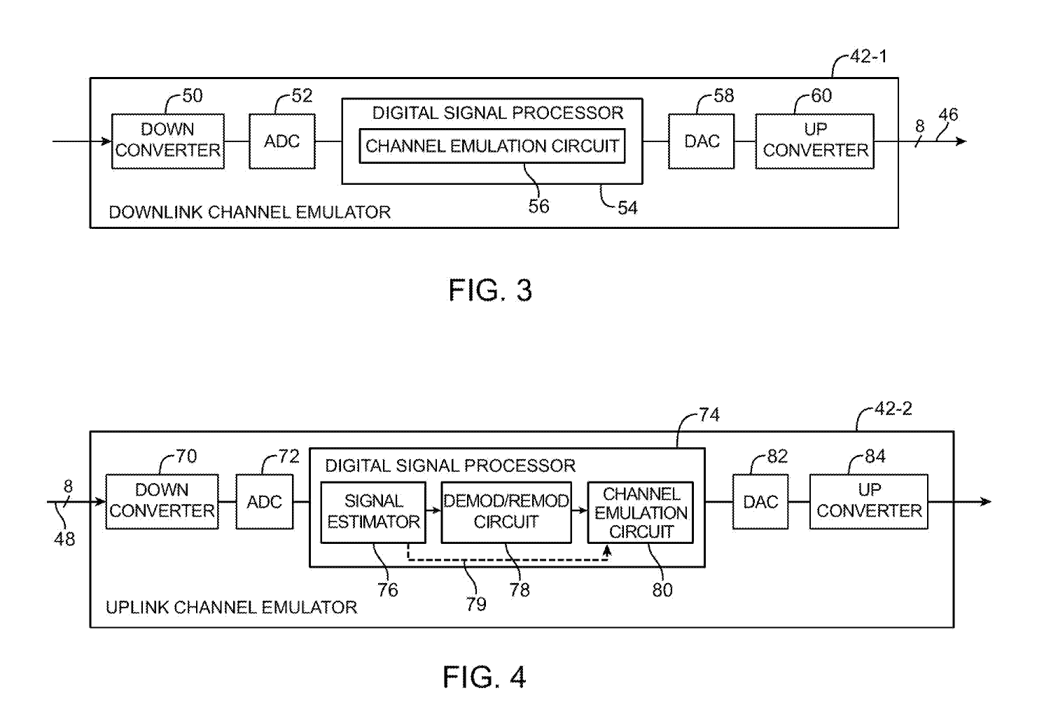

FIG. 3 is a diagram of illustrative downlink channel emulator 42-1. As shown in FIG. 3, channel emulator 42-1 may include down converter 50, analog-to-digital converter (ADC) 52, digital signal processor (DSP) 54, digital-to-analog converter (DAC) 58, up converter 60, and other control circuitry. Digital signal processor 54 may include channel emulation circuit 56.

FIG. 4 is a diagram of illustrative uplink channel emulator 42-2. As shown in FIG. 4, channel emulator 42-2 may include down converter 70, ADC 72, digital signal processor 74, DAC 82, up converter 84, and other control circuitry. Digital signal processor 74 may include signal estimator 76, demodulation/remodulation circuit 78, and channel emulation circuit 80.

Accurate uplink emulation may depend on accurately performing signal estimation. Antennas 26 coupled to uplink circuitry 34 may be positioned at desired locations on antenna mounting structure 24 to provided uplink spatial fading (e.g., test system 22 may provide fading uplink channel emulation). The RF signals received using these antennas 26 may be conveyed to channel emulator 42-2. Down converter 70 down converts the RF signals. ADC 72 may convert the RF signals from analog signals to digital signals.

Signal estimator 76 may perform signal estimation for each independent signal stream transmitted from DUT 10. Array processing techniques may be used to analyze the digital signals to extract (isolate) each independent stream via a cost function optimization process. For example, signal estimator 76 may be used to provide signal performance values such as signal-to-noise ratio (SNR), highest signal power, and other performance metrics for each independent stream.

One suitable cost function optimization uses a least mean square algorithmic approach. For example, signals for each independent stream may be estimated based on an array of received signals using the following expressions.

min<∥W₁S−S₁′∥²> (1)

min<∥W₂S−S₂′∥²> (2)

S₁=W₁S (3)

S₂=W₂S (4)

As shown in expression 1, a suitable weighting factor W₁ that minimizes the square of the magnitude of the difference between the product of W₁ and the array of received signals S and a model prediction array of a first independent stream S₁′ may be determined. As shown in expression 2, a suitable weighting factor W₂ that minimizes the square of the magnitude of the difference between the product of W₂ and received signal array S and a model prediction array of a second independent stream S₂′ may be determined. Estimation and extraction of each independent stream can then be determined by calculating the product of the respective weight factors and the received signal array. As shown in equations 3 and 4, first independent stream S₁ may be calculated by taking the product of W₁ and S, whereas second independent stream S₂ may be calculated by taking the product of W₂ and S.

In other suitable array processing algorithms such as pilot tone analysis, signal estimation of each independent data stream need not be performed.

If desired, circuit 78 may be used to demodulate and remodulate the digital signals. Demodulating and remodulating the digital signals in this way may serve to reduce undesired noise from the digital signals. Channel emulation circuit 80 may receive the “clean” version of the digital signals.

Channel emulation circuit 80 may be used to perform real-world channel emulation. Channel emulation circuit 80 may be loaded with a desired channel model (e.g., a geometric channel model, a stochastic channel model, etc.). Channel emulation circuit 80 may have a control input that receives the estimated values produced by signal estimator 76 over control line 79. The control signals on line 79 may serve to configure channel emulation circuit 80 to accurately model real-world channels. For example, channel emulation circuit 80 may be used to accurately model a MIMO system employing multiple simultaneous transmissions that use the wireless local area network protocol (e.g., IEEE 802.11n), the WiMAX communications protocol, 3GPP Long Term Evolution (LTE) standard, etc. Channel emulation circuit 80 may also be used to accurately model RF signal transmission in single-input-single-output (SISO) systems, if desired.

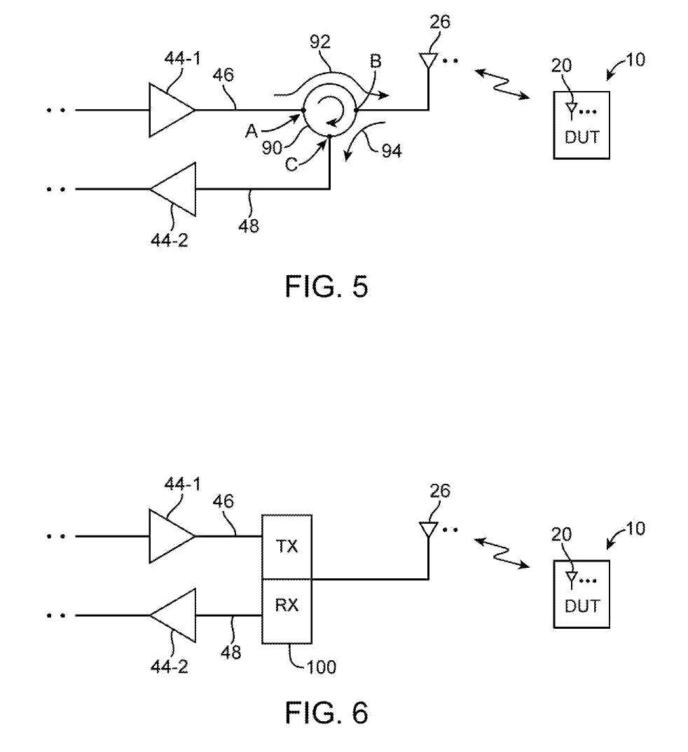

As shown in FIG. 5, antennas 26 may be shared between downlink circuitry 32 and uplink circuitry 34 (e.g., each antenna 26 may be used to transmit and receive radio-frequency signals during wireless testing). For example, each antenna 26 may be coupled to amplifier circuits 44-1 and 44-2 through a directional coupler such as directional coupler 90. Directional coupler 90 may have three ports such as ports A, B, and C. Port A of coupler 90 may be connected to the output of amplifier 44-1. Port B of coupler 90 may be connected to the input of amplifier 44-2. Port C of coupler 90 may be connected to antenna 26.

During uplink signal transmission, directional coupler 90 may pass radio-frequency signals from port A to port B (as indicated by arrow 92). The RF signals may be transmitted wirelessly from test antenna 26 to antenna 20 of DUT 10. During downlink signal reception, directional coupler 90 may route radio-frequency signals from port B to port C (as indicated by arrow 94). The radio-frequency signals conveyed in the direction of arrow 94 represent RF signals wirelessly transmitted from antenna 20 of DUT 10 to test antenna 26. Ports A and C may be isolated by coupler (e.g., no signals can pass between ports A and C).

In another suitable arrangement, antenna 26 may be coupled to amplifier circuits 44-1 and 44-2 through a duplexer such as duplexer 100. As shown in FIG. 6, antennas 26 may be shared between downlink circuitry 32 and uplink circuitry 34. Duplexer 100 allows antennas 26 to transmit and receive radio-frequency signals to and from antennas 20 of DUT 10.

Duplexer 100 may provide time-division duplexing (TDD), frequency-division duplexing (FDD), or other types of duplexing. Time-division duplexing transmits and receives radio-frequency signals at different time slots by time-division multiplexing the transmit and receive RF signals, whereas frequency-division duplexing operate the transmitter and receiver at different carrier frequencies. Any suitable type of duplexing circuit may be used.

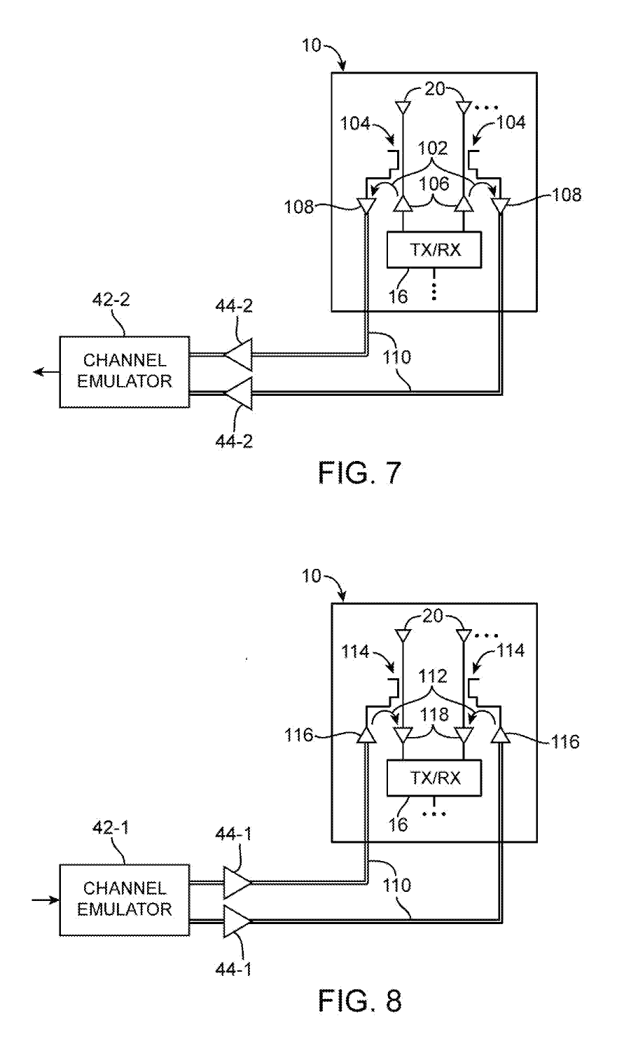

Over-the-air testing may be bypassed by conveying radio-frequency signals between the channel emulators and transceiver circuitry 16 through fiber optic cabling. As shown in FIG. 7, cables such as fiber optic cables 110 may be used to carry radio-frequency signals generated by transceiver 16 to channel emulator 42-2 in a conducted manner.

During uplink testing, transceiver 16 may generate radio-frequency signals at its output. The RF signals may be amplified using power amplifiers 106. DUT 10 may include couplers such as directional couplers 104 that couple the RF signals in the direction of arrows 102 to RF-to-optical connectors 108. The RF-to-optical connectors (sometimes referred to as optical connectors) may be used to convert optical signals into analog signals that can be transmitted over electrical wiring. The RF signals are routed to channel emulator 42-2 through connectors 108 and amplifier circuits 44-2 over fiber optic cables 110 (as an example).

FIG. 8 shows a test setup that bypasses wireless transmission during downlink testing. As shown in FIG. 8, channel emulator 44-1 may be coupled to DUT 10 through fiber optic cables 110. RF signals generated by channel emulator 42-1 may be amplified or attenuated by circuits 44-1. The RF signals at the output of circuits 44-1 are fed to optical-to-RF connectors 116. The RF signals may be coupled in the direction of arrows 112 through coupler 114. The RF signals may be amplified by amplifiers such as low noise amplifiers 118. The amplified signals at the output of amplifiers 118 may be fed to transceiver 16 for further processing. Testing DUT 10 using fiber optic cables may present minimal impact to device radiated performance.

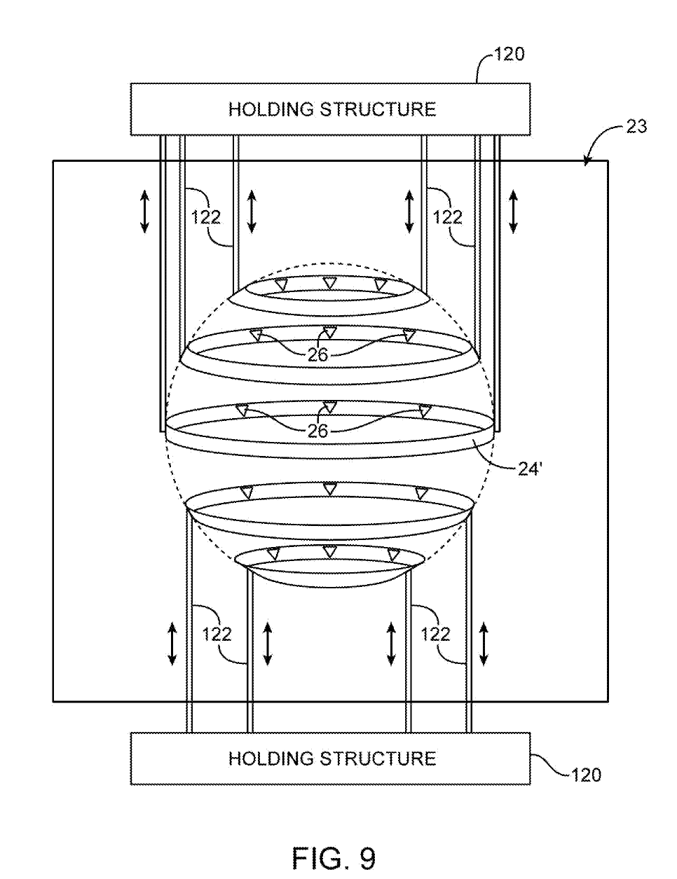

More than one ring-shaped antenna mounting structure may be used in test chamber 23 (e.g., to provide three-dimensional coverage by antennas 26). As shown in FIG. 9, multiple ring-shaped antenna mounting structures of varying sizes may be used to form a spherical antenna mounting structure such as spherical antenna mounting structure 24′. Each of the multiple ring-shaped antenna mounting structures in antenna mounting structure 24′ may be lined by absorbers. OTA antennas 26 may be embedded in the absorbers.

Antenna mounting structure 24′ may be used to perform three-dimensional tests. Antenna structure 50 may have a diameter of 7 m or more, a diameter that is greater than 1 m, or other suitable size. Antenna mounting structure 24′ may generate a feasibility region that has a diameter of 1 m (as an example).

Antenna mounting structure 24′ of FIG. 5 may be supported by support structures 120. As shown in FIG. 9, some support structures 122 may extend downwards from an upper holding structure (e.g., holding structure 120) and some support structures may extend upwards from a lower holding structure. If desired, antenna structure 24′ may be lowered into place in the test chamber using only an upper holding structure (e.g., the position of each of the multiple ring structures in antenna structure 24′ may be adjusted by using motors in the upper holding structure). If desired, antenna structure 50 may be raised into position using only a lower holding structure (e.g., using motors or other positioning equipment). In this type of configuration, each of the multiple ring-shaped antenna mounting structures in antenna structure 24′ can be supported by the lower holding structure. Both upper and lower sets of motors or other positioning equipment may be used to adjust the positions of antennas 26 if desired. Arrangements in which antenna positioning equipment is located to the side of antennas 26 may also be used.

Antenna structure 24′ may be retracted (e.g., using a nested telescope-type arrangement) when not in use or when it is desired to allow for placement of a DUT at the center of test chamber 23. Lines 46 and 48 may be routed through holding structures 46 to provide each antenna 26 with appropriate connection to circuitry 32 and 34.

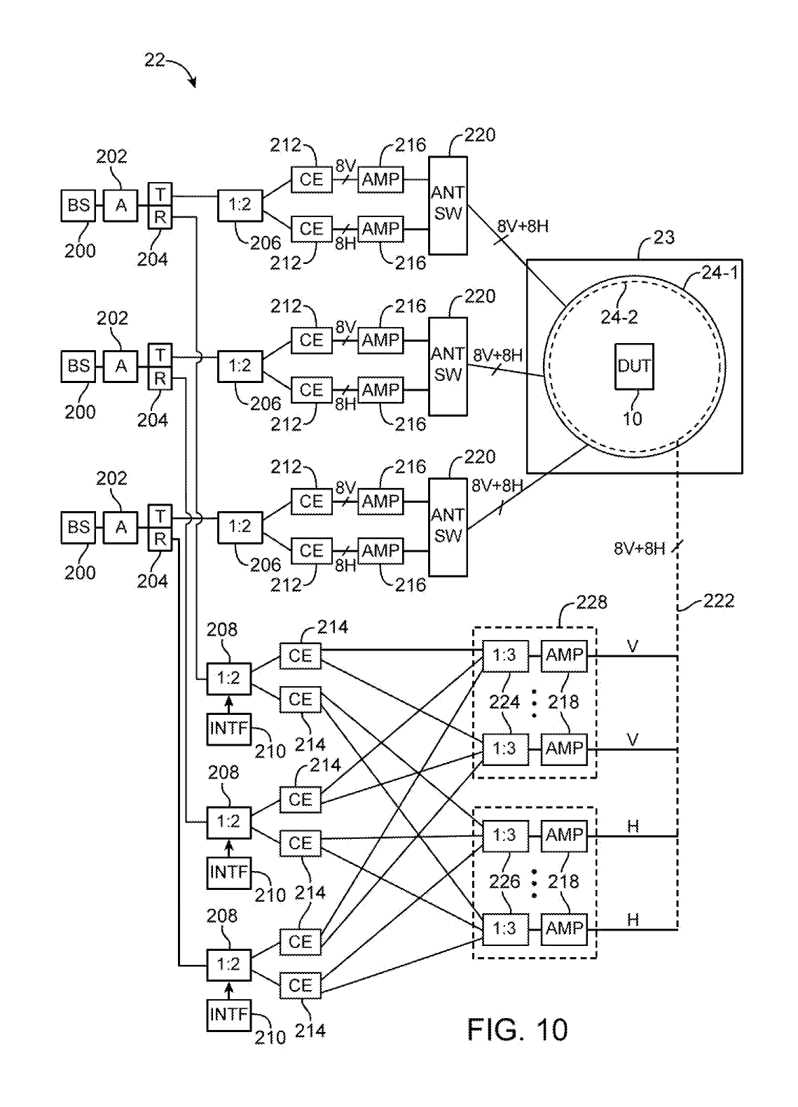

In another suitable arrangement, system 22 may be configured to perform bidirectional wireless testing between multiple base stations and DUT 10. As shown in FIG. 10, first, second, and third base stations (e.g., base station emulators or real base stations) 200 may communicate wirelessly with DUT 10. Base stations 200 may, as an example, be Node B network elements that can support Wideband Code Division Multiple Access (W-CDMA), High-Speed Downlink Access (HSPA), and other 3 G communications standards.

Test system 22 may be configured to support FDD communications standards such as Global System for Mobile Communications (GSM), Enhanced Data Rates for GSM Evolution (EDGE), CDMA2000, WCDMA-FDD, Evolution-Data Optimized (EV-DO), HSPA, LTE-FDD, WiMAX-FDD, and other FDD protocols and may be configured to support TDD communications standards such as WiFi®, Bluetooth®, WCDMA-TDD, Time Division Synchronous CDMA (TD-SCDMA), LTE-TDD, WiMAX-TDD, and other TDD protocols.

The test setup of FIG. 10 may be used to test the effects of spatial interference (e.g., interference among the multiple base stations) and desired handover mechanisms.

For example, each base station 200 may represent a respective cell tower. Test system 22 may be used to monitor telephone call quality (e.g., by monitoring dropped call percentage), data rate, and other voice/data performance metrics while DUT 10 experiences intrafrequency handover (e.g., when DUT 10 is transitioning between different channels), interfrequency handover (e.g., when DUT 10 is transitioning between using different scrambling codes), cross-technology handover (e.g., when DUT 10 is transitioning between cells that use different communications standards), and other cell crossing scenarios. As an example, telephone call quality may be monitored while DUT 10 is being used to surf the Internet. As another example, a portion of base stations 200 may be replaced with signal generators to model sources of spatial interference when performing single sector testing (e.g., testing in a single channel).

Each base station 200 may be coupled to a respective radio-frequency duplexer 204 through amplifier 202. Amplifier 202 may serve as an attenuator operable to balance downlink signal power with uplink signal power. Each duplexer (or isolator) 204 may have transmit (T) and receive (R) terminals. The transmit terminal of duplexer 204 may be coupled to a corresponding radio-frequency splitter 206, whereas the receive terminal of duplexer 204 may be coupled to a corresponding radio-frequency combiner 208.

Test system 22 may include a fixed number of channel emulators. For example, test system 22 may include six channel emulators (CEs) 212 that are used for downlink transmission and six channel emulators 214 that are used for uplink transmission. Each splitter 206 may be a 1:2 splitter (e.g., a circuit that couples its input signals onto two output paths), because there are three base stations 200. In general, the type of splitter used (e.g., a 1:2, 1:3, or 1:6 radio-frequency splitter) depends on the number of active base stations 200.

Each splitter 206 may be coupled to first and second channel emulators 212 (e.g., downlink channel emulators of the type described in connection with FIGS. 2 and 3). First channel emulator 212 may serve to perform channel emulation for eight separate vertically polarized RF signals, whereas second channel emulator 212 may serve to perform channel emulation for eight separate horizontally polarized RF signals, as an example. The eight vertically polarized signals (8V) and the eight horizontally polarized signals (8H) may be coupled to a corresponding antenna switching circuit 220 through amplifier circuits 216. Amplifier circuits 216 may serve to provide desired power amplification/attenuation to emulate realistic downlink path loss values. Amplifier circuit 216 may be formed as a portion of channel emulator 212, if desired. Antenna switching circuit 220 may be used to route the 8V and 8H signals to an appropriate number of test antennas.

Antenna mounting structure 24 of FIG. 2 may include a first ring portion 24-1 and a second ring portion 24-2. First and second ring portions 24-1 and 24-2 may be placed within test chamber 23. As shown in FIG. 10, the downlink signals from each of base stations 200 may be fed to dual-polarized test antennas mounted on ring portion 24-1. There may, as an example, be 24 dual-polarized antennas attached to ring portion 24-1, eight of which transmit downlink signals associated with the first base station, eight of which transmit downlink signals associated with the second base station, and eight of which transmit downlink signals associated with the third base station. These test antennas may be equally spaced along ring portion 24-1.

In response to receiving the downlink signals, DUT 10 may transmit uplink RF signals. There may be eight dual-polarized antennas mounted on ring portion 24-2, each of which receives the uplink signals from DUT 10. These uplink test antennas may be equally spaced along ring portion 24-2. The uplink signals conveyed along path 222 may be separated into eight vertically polarized signals (8V) and eight horizontally polarized signals (8H). Each of the 8V signals may be fed to a respective radio-frequency splitter 224 through amplifier circuit 218 in region 228, whereas each of the 8H signals may be fed to a respective splitter 226 through amplifier circuit 218 in region 230. Amplifier circuits 218 may serve to provide desired power amplification/attenuation to emulate realistic uplink path loss values. Splitters 224 and 226 may be 1:3 radio-frequency splitters (e.g., a circuit that couples its input signals to three output paths), because the uplink signals on are to be transmitted to three different base stations 200. Splitters 224 and 226 need not be used if there is only one active base station 200 currently being used during testing.

Each of the three base stations may be coupled to associated first and second uplink channel emulators 214 (e.g., uplink channel emulators of the type described in connection with FIGS. 2 and 4). Each splitter 224 in region 228 may be coupled to the first channel emulator 214 associated with each of the three base stations. Each splitter 226 in region 230 may be coupled to the second channel emulator 214 associated with each of the three base stations. Each pair of first and second channel emulators 214 may be coupled to the associated base station through radio-frequency combiner 208 (e.g., a circuit that combines the input signals it receives onto a single output path). In particular, the output path of each combiner 208 may connected to the receive terminal of associated duplexer 204.

An interference circuit such as interference circuit 210 may be coupled to combiner 208. Interference circuit 210 may be a signal generator, a user device, or other noise generating equipment that can be used to introduce a predictable (predetermined) amount of interference and/or additional path loss into the uplink path. If desired, circuit 210 may be formed as an integral portion of combiner 208.

The setup of FIG. 10 is merely illustrative. If desired, any number of Node B elements may be used during wireless testing (e.g., one or more Node B circuits, two or more Node B circuits, three or more Node B circuits, six or more Node B circuits, etc.). If desired, test system 22 may include less than six downlink channel emulators 212 and less than six uplink channel emulators 214 or more than six downlink channel emulators 212 and more than six uplink channel emulators 214.

If desired, amplifier circuits 216 may be formed as a portion of channel emulator 212, whereas amplifier circuits 218 may be formed as a portion of channel emulator 214. Channel emulators 212 may be configured to emulate a fading downlink channel and to provide predetermined downlink path loss (e.g., to model a desired downlink response). Channel emulators 214 may be configured to emulate a fading uplink channel and to provide predetermined uplink path loss (e.g., to model a desired uplink response).

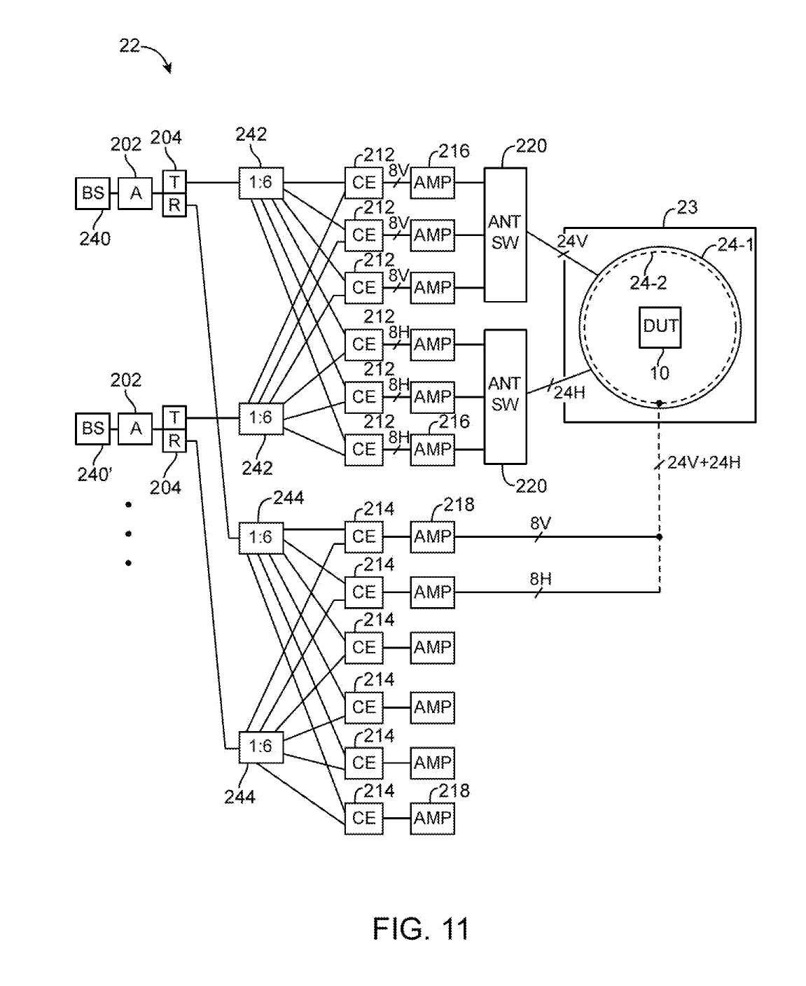

The placement and orientation of the test antennas within chamber 23, the chamber itself, and the placement of DUT 10 within the test chamber may introduce a corresponding chamber response. Downlink and uplink channel emulators 212 and 214 may further be configured to provide an inverse chamber response that equalizes the chamber response for each test antenna so that channel emulation is less dependent on the particular antenna arrangement within chamber 23. In another suitable arrangement, test system 22 may be configured to perform bidirectional wireless testing in an environment with minimal spatial interference. As shown in FIG. 11, base station 240 may be coupled to each of the six downlink channel emulators 212 and to each of the six uplink channel emulators 214. Base station 240 may, as an example, be an enhanced Node (eNode) B network element that can support the LTE standard and other 4 G communications standards.

In particular, base station 240 may be coupled to duplexer 204 through amplifier 202. Duplexer (or isolator) 204 may have a transmit terminal that is coupled to splitter 242 and a receive terminal that is coupled to combiner 244.

Splitter 242 may be a 1:6 splitter that couples the downlink signals from base station 240 to each of six channel emulators 212. A first portion of channel emulators 212 may be used to generate vertically polarized signals, whereas a second portion of channel emulators 212 may be used to generate horizontally polarized signals. Each of channel emulators 212 in the first portion of channel emulators may, for example, be used to provide eight vertically polarized signals (8V). Each of channel emulators 212 in the second portion of channel emulators may be used to provide eight horizontally polarized signals (8H).

The 24 vertically polarized signals are coupled to 24 dual-polarized antennas on antenna mounting portion 24-1 through amplifier circuits 216 and antenna switch 220. Similarly, the 24 horizontally polarized signals are coupled to the same 24 dual-polarized antennas on antenna mounting portion 24-1 through associated amplifier circuits 216 and antenna switch 220. The 24 dual-polarized antennas on ring portion 24-1 may be spaced equally along ring 24-1.

There may be 24 dual-polarized antennas attached to antenna mounting portion 24-2. Only eight of these 24 test antennas may be used to feed uplink signals back to base station 240. As shown in FIG. 11, eight vertically polarized signals are fed to a first active channel emulator 214 through first amplifier circuit 218, whereas eight horizontally polarized signals are fed to a second active channel emulator 214 through second amplifier circuit 218. The remaining four uplink channel emulators 214 may be placed in an inactive mode. Each of the six channel emulators 214 may be coupled to combiner 244.

If only one base station 240 is active during wireless testing, maximum signal fidelity can be obtained because there are no other sources of spatial interference. If desired, an additional eNode B element 240′ may be tested in parallel with eNode B element 240 to model multi-stream radio-frequency signal transmission in a MIMO system. In this arrangement, downlink channel emulator 212 may have two “input” ports, whereas uplink channel emulator 214 may have two “output” ports. The test setup of FIG. 11 may be configured to support wireless testing with any suitable number of eNode B circuits.

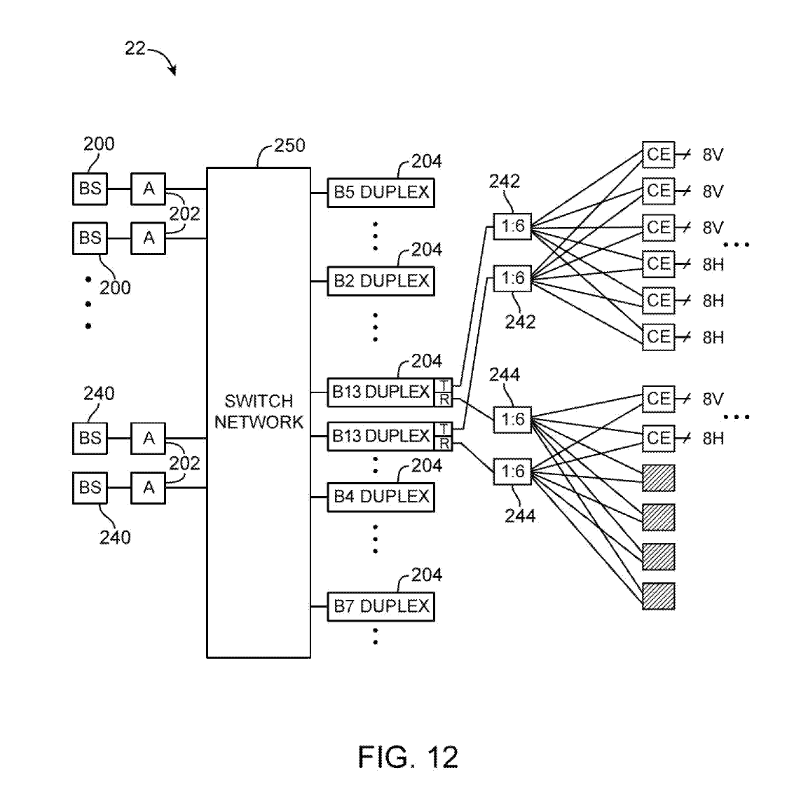

FIG. 12 is a diagram illustrating how the base stations may be selectively coupled to the channel emulators. As shown in FIG. 12, a switch network such as switch network 250 may be coupled between the base stations and duplexers 204. Switch network 250 may have first ports coupled to base stations 200 and 240, base station emulators, signature generators, access points, and other types of test equipment. Switch network 250 may have second ports coupled to different types of duplexers 204. For example, each duplexer 204 may be operable in a respective frequency band.

Switch network 250 may be configured to connect a portion of the first ports to a portion of the second ports (e.g., to route signals from selected base stations to duplexers operating in the band under test). In the example of FIG. 12, first and second base stations 240 may be selectively coupled to B13 duplexer 204 to perform bidirectional testing in band 13. B13 duplexers 204 may be coupled to the channel emulators using the arrangement described in connection with FIG. 11. If desired, switch network 250 may be used to connect any number of base stations to any number and type of duplexers 204.

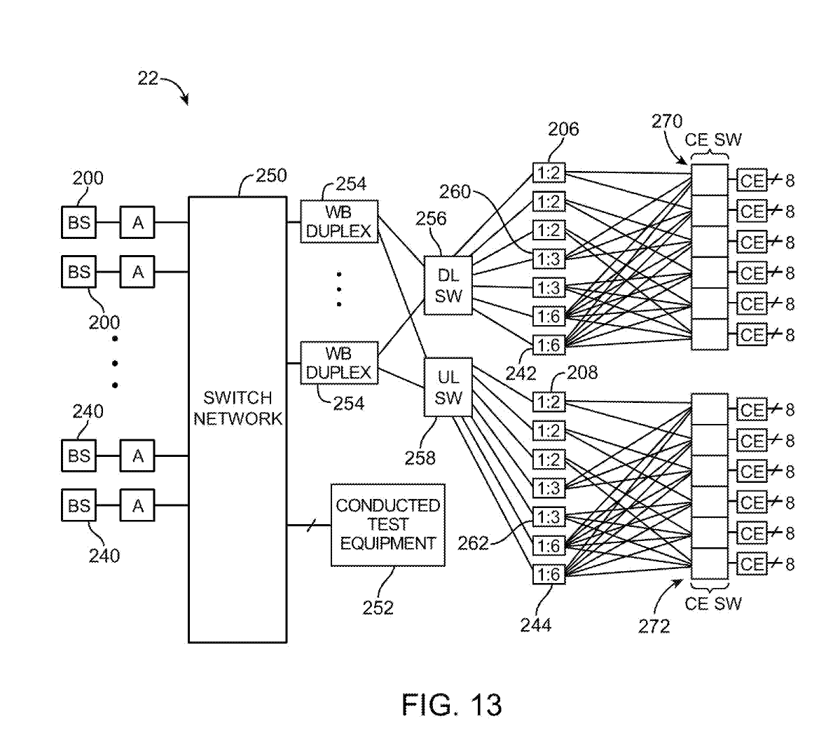

FIG. 13 is a diagram illustrating the configurability of test system 22 for testing a wide variety of scenarios. As shown in FIG. 13, switch network 250 may be coupled between the base stations and duplexers 254, downlink switch circuit 256 may be coupled between duplexers 254 and the RF splitters, uplink switch circuit 258 may be coupled between duplexers 254 and the RF combiners, channel emulator switch circuitry 270 may be coupled between the RF splitters and the downlink channel emulators, and channel emulator switch circuitry 272 may be coupled between the RF combiners and the uplink channel emulators. Duplexers 254 may be wideband duplexers capable of supporting radio-frequency duplexing in multiple bands.

As discussed in connection with FIG. 12, switch network 250 of FIG. 13 may be used to couple selected base stations to corresponding duplexers 254. Downlink switches 256 may be used to couple duplexers 254 to the appropriate type of RF splitter depending on the number of active base stations. For example, 1:2 splitters 206 may be switched into use when there are three active base stations 200, 1:3 splitters 260 may be switched into use when there are two active base stations 200, and 1:6 splitters 242 may be switched into use when there is one active Node B 200 or when there are multiple eNode Bs 240. Similarly, uplink switches 258 may be used to couple duplexers to the appropriate type of RF combiner depending on the number of active base stations. For example, 1:2 combiners 208 may be switched into use when there are three active base stations 200, 1:3 combiners 262 may be switched into use when there are two active base stations 200, and 1:6 combiners 244 may be switched in to use when there is one active Node B 200 or when there are multiple active eNode Bs 240.

Channel emulator switch circuitry 270 and 272 may be used to connect the channel emulators to the appropriate type of splitters/combiners. As an example, when there are two active Node Bs 200, circuitry 270 may be used to connect 1:3 splitters 260 to the downlink channel emulators, whereas circuitry 272 may be used to connect 1:3 combiners 262 to the uplink channel emulators. As another example, when there are two active eNode Bs 240, circuitry 270 may be used to connect 1:6 splitters 242 to the downlink channel emulators, whereas circuitry 272 may be used to connect 1:6 combiners 24 to the uplink channel emulators.

The test setup of FIG. 13 is merely illustrative. There may be any suitable number and type of splitters and combiners and any desired number of uplink and downlink channel emulators. Switching circuitry 250, 256, 270, 272, and other control circuitry may be used to provide any desired degree of configurability (e.g., to allow bidirectional wireless testing using any number of base stations in any desired band). If desired, switch network 250 may couple selected base stations to test equipment 252 to perform conducted testing. Test equipment 252 may include spectrum analyzers, network analyzers, and other types of radio-frequency test units.

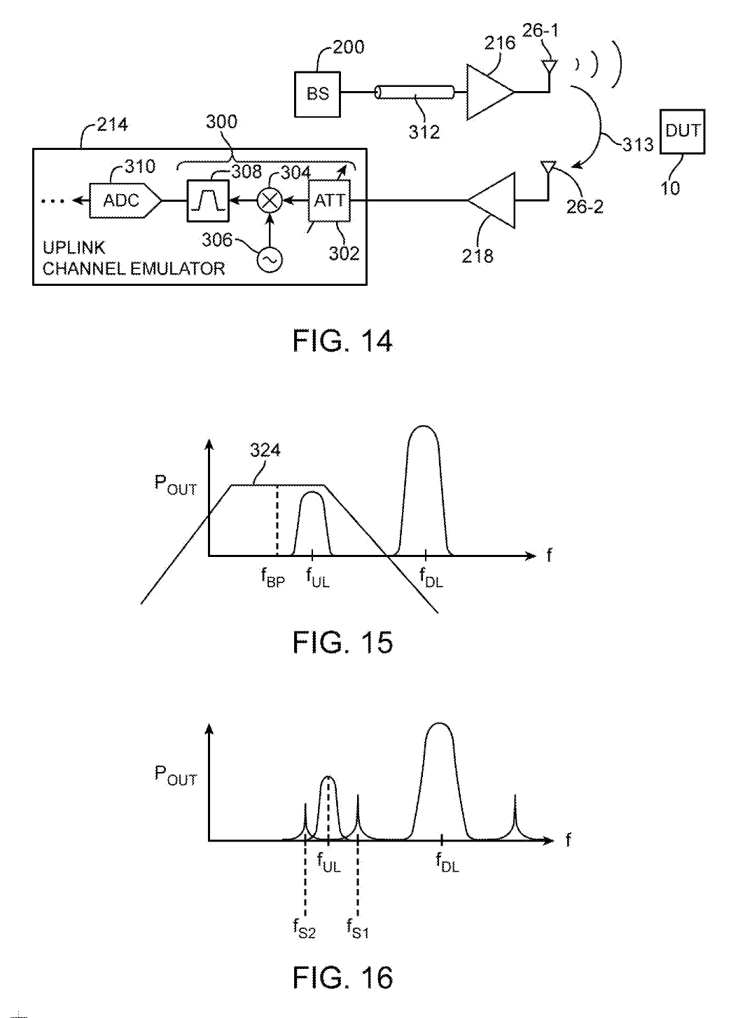

Downlink signals transmitted from a base station to DUT 10 may interfere with uplink signals transmitted from DUT 10 back to the base station. As shown in FIG. 14, base station 200 may transmit downlink RF signals to DUT 10 using dual-polarized antenna 26-1 attached to antenna mounting portion 24-1. The downlink signals may be conveyed through downlink path 312 (e.g., through amplifier 202, duplexer 204, splitter 242, channel emulators 212, and other downlink switching circuitry) and amplifier circuit 216. The downlink signals are intended to be received using DUT 10. These downlink signals may, however, leak into the uplink path, as indicated by arrow 313.

The uplink signals (e.g., including RF signals transmitted from DUT 10 and the downlink interference signals) may be received by dual-polarized antenna 26-2 attached to antenna mounting portion 24-2. The uplink signals may be conveyed through amplifier circuit 218 to uplink channel emulator 214. Channel emulator 214 may include down converter circuitry 300 coupled in series with analog-to-digital converter (ADC) 310.

Down converter circuitry 300 may include attenuator 302, mixer 304, band-pass filter 308, local oscillator 306, and other radio-frequency circuitry. Attenuator 302 may have an input coupled to amplifier 218 and an output. Mixer 304 may have a first input coupled to the output of attenuator 302, a second input coupled to local oscillator 306, and an output. Filter 308 may have an input coupled to the output of mixer 304 and an output coupled to ADC 310. Connected using this arrangement, attenuator 302 may serve to provide input power attenuation at the input of channel emulator 214 to maximize signal to interference-plus-noise ratio (SINR). The input power attenuation setting of attenuator 302 may be determined during pre-test calibration operations by monitoring the SINR while radiating RF signals at maximum output power from DUT 10. In general, downlink channel emulator 212 and uplink channel emulator 214 may be tuned to provide desired SINR values that properly emulate the wireless transmission in real-world environments.

Band-pass filter 308 may serve to filter undesired interference signals (e.g., to isolate the signals in the uplink band from signals in the downlink band and other bands). FIG. 15 is a plot illustrating uplink signals transmitted in an uplink band centered at f_{UL} and downlink interference signals transmitted in a downlink band centered at frequency f_{DL}. As shown in FIG. 15, the output power level of downlink signals may be greater than the output power level of uplink signals. Filter 308 may be used to filter (attenuate) signals outside the uplink band and may therefore sometimes be referred to as a channel select filter.

Filter 308 may, for example, provide a band-pass filter response 324 that is centered at f_{BP}. Filter response 324 may be shifted in frequency to provide maximum downlink signal attenuation and to further enhance SINR (e.g., f_{BP} is shifted to the left of f_{UL} to maximize attenuation of signals at f_{DL}). Attenuating the downlink signals by adjusting filter 308 in this way may increase the dynamic range of the uplink signals.

The interference downlink signals may also generate out-of-band spurs that can degrade the uplink signals. As shown in FIG. 16, the downlink signals may generate spurs/noise at frequency f_{S1} and f_{S2}. These spurs may occur at intermodulation frequencies and other frequencies. Care may be taken to place these spurious signals outside of the uplink band. As an example, the uplink signals may be offset in frequency by adjusting oscillator 306 to shift the uplink band away from the downlink spurs. If desired, the downlink signals may be offset by adjusting downlink channel emulation to move the downlink spurs away from the uplink band. One suitable result in which the downlink spurs and noise are located outside of the uplink band is illustrated in FIG. 16.

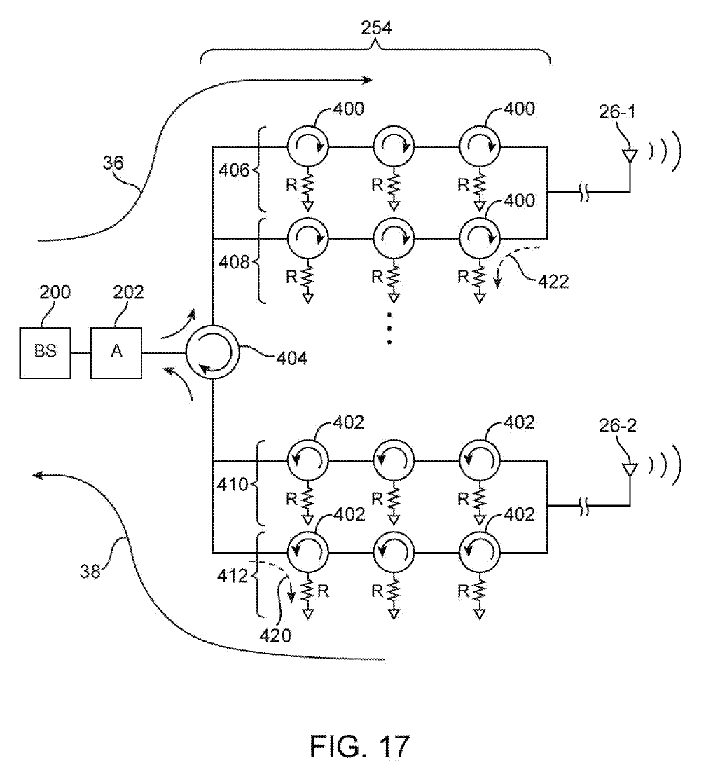

In time-division duplexing (TDD) systems, wideband duplexers 254 of the type described in connection with FIG. 13 may be implemented using multi-stage isolators coupled in parallel. As shown in FIG. 17, duplexer 254 may include multiple groups downlink isolators and multiple groups of uplink isolators. For example, first and second groups 406 and 408 may each include three downlink isolators 400 connected in a chain between a given isolator 404 and downlink antenna 26-1, whereas first and second groups 410 and 412 may each include three uplink isolators 402 connected in a chain between isolator 404 and uplink antenna 26-2. Isolators 400 and 402 may each have a drain terminal that is coupled to ground through resistor R.

Groups 406 and 410 may be associated with a first band, whereas groups 408 and 412 may be associated with a second band that is different than the first band. Groups 406 and 410 may be coupled in parallel, whereas groups 408 and 412 may be coupled in parallel. Consider a scenario in which duplexer 254 is configured to operate in the first band. Downlink signals will be transmitted in the direction of arrow 36 through group 406, whereas uplink signals will be transmitted in the direction of arrow 38 through group 410. Downlink signals leaking back into group 408 in the direction of arrow 38 may be drained through the ground terminals, as indicated by path 422. Similarly, uplink signals leaking back into group 412 in the direction of arrow 36 may be drained through the ground terminals, as indicated by path 420. Wideband isolator 254 arranged using this configuration may be used to provide high isolation between multiple communications bands.

The circuit implementation of FIG. 17 is merely illustrative. If desired, duplexer 254 may include any suitable number of groups to support operation in any desired number of communications bands, where each group may include any number of isolators connected in series. Duplexers 254 may be FDD-based circuits, TDD-based circuits (e.g., circuits that can provide high isolation), or other circuits containing switches synchronized to transmit and receive radio-frequency signals to and from the base stations.

The foregoing is merely illustrative of the principles of this invention and various modifications can be made by those skilled in the art without departing from the scope and spirit of the invention.

What is claimed is:

1. A wireless test system with a test chamber in which at least one device under test is tested, comprising:
a first plurality of test antennas;
a second plurality of test antennas;
a plurality of base stations;
downlink circuitry coupled between the first plurality of test antennas and a portion of the base stations; and
uplink circuitry coupled between the second plurality of test antennas and the portion of the base stations, wherein the uplink circuitry is configured to provide predetermined uplink path loss.

2. The wireless test system defined in claim 1, further comprising:
an antenna mounting structure having first and second ring-shaped portions, wherein the first plurality of test antennas comprise dual-polarized antennas mounted on the first ring-shaped portion and wherein the second plurality of test antennas comprise dual-polarized antennas mounted on the second ring-shaped portion.

3. The wireless test system defined in claim 1, wherein the downlink circuitry comprises a plurality of downlink channel emulators configured to emulate a fading downlink channel and wherein the uplink circuitry comprises a plurality of uplink channel emulators configured to emulate a fading uplink channel.

4. The wireless test system defined in claim 3, wherein the downlink circuitry further comprises a plurality of radio-frequency splitters coupled between the portion of the base stations and the downlink channel emulators and wherein the uplink circuitry further comprises a plurality of radio-frequency combiners coupled between the portion of the base stations and the uplink channel emulators.

5. The wireless test system defined in claim 4, wherein the downlink circuitry further comprises downlink amplifier circuits coupled between the downlink channel emulators and the first plurality of test antennas, wherein the uplink circuitry further comprises uplink amplifier circuits coupled between the uplink channel emulators and the second plurality of test antennas, wherein the downlink amplifier circuits are configured to provide predetermined downlink path loss, and wherein the uplink amplifier circuits are configured to provided the predetermined uplink path loss.

6. The wireless test system defined in claim 5, further comprising:
a plurality of duplexing circuits, wherein a portion of the duplexing circuits is coupled between the radio-frequency splitters and the portion of the base stations, and wherein the portion of the duplexing circuits is coupled between the radio-frequency combiners and the portion of the base stations.

7. The wireless test system defined in claim 6, further comprising:
a switch circuit, wherein the switch circuit is configured to connect the portion of the base stations to the portion of the duplexing circuits.

8. The wireless test system defined in claim 7, further comprising:
at least one signal generator, wherein the switch circuit is operable to connect the at least one signal generator to the portion of the duplexing circuits.

9. The wireless test system defined in claim 6, wherein the plurality of duplexing circuits comprises a plurality of multiband isolator circuits.

10. The wireless test system defined in claim 3, wherein each of the uplink channel emulators comprises a filter configured to attenuate downlink radio-frequency signals.

11. The wireless test system defined in claim 3, wherein the test chamber provides a chamber response for each of the first and second plurality of test antennas, wherein the uplink and downlink channel emulators are configured to provide an inverse chamber response that equalizes the chamber response, and wherein radio-frequency signals propagating within the test chamber are altered according to the inverse chamber response.

12. The wireless test system defined in claim 1, further comprising:
an additional device under test placed within the test chamber.

13. A wireless test system with a test chamber in which a device under test is tested, comprising:
a plurality of antennas in the test chamber;
downlink circuitry coupled to a first portion of the antennas; and
uplink circuitry coupled to a second portion of the antennas, wherein the uplink circuitry is configured to provide a predetermined signal to interference-plus-noise ratio.

14. The wireless test system defined in claim 13, further comprising:
at least one base station coupled to the downlink and uplink circuitry, wherein the base station is configured to transmit downlink radio-frequency signals through the downlink circuitry to the first portion of the antennas, and wherein the base station is configured to receive uplink radio-frequency signals through the uplink circuitry from the second portion of the antennas.

15. The wireless test system defined in claim 14, wherein the downlink circuitry comprises a plurality of downlink channel emulators coupled between the base station and the first portion of the antennas, wherein the uplink circuitry comprises a plurality of uplink channel emulators coupled between the base station and the second portion of the antennas, wherein the downlink channel emulators are configured to emulate a downlink fading channel, and wherein the uplink channel emulators are configured to emulate an uplink fading channel and are configured to provide the predetermined signal to interference-plus-noise ratio.

16. The wireless test system defined in claim 15, wherein the downlink circuitry further comprises a plurality of radio-frequency splitters coupled between the base station and of downlink channel emulators, and wherein the uplink circuitry further comprises a plurality of radio-frequency combiners coupled between the base station and of uplink channel emulators.

17. The wireless test system defined in claim 16, further comprising:
a plurality of signal generators each of which is connected to a respective one of the radio-frequency combiners, wherein the plurality of signal generators are configured to generate predetermined uplink interference signals.

18. The wireless test system defined in claim 16, wherein the downlink circuitry further comprises a plurality of downlink amplifier circuits coupled between the downlink channel emulators and the first portion of the antennas, wherein the uplink circuitry further comprises a plurality of uplink amplifier circuits coupled between the uplink channel emulators and the second portion of the antennas, wherein the downlink amplifier circuits are configured to provide predetermined downlink path loss, and wherein the uplink amplifier circuits are configured to provided predetermined uplink path loss.

19. The wireless test system defined in claim 15, wherein each of the uplink channel emulators comprises a filter configured to attenuate the downlink radio-frequency signals received by the second portion of the antennas.

20. The wireless test system defined in claim 13, wherein the plurality of antennas comprises a plurality of dual-polarized antennas.

21. A wireless test system for testing a plurality of devices under test, comprising:
a test chamber in which the plurality of devices under test is tested; and
a ring of test antennas within the test chamber that surrounds the device under test, wherein the test antennas in the ring comprise a first group of dual-polarized antennas configured to transmit radio-frequency signals and a second group of dual-polarized antennas configured to receive radio-frequency signals.

22. The wireless test system defined in claim 21, further comprising:
a plurality of base stations;
downlink circuitry coupled between the base stations and the first group of dual-polarized antennas, wherein the downlink circuitry is configured to provide predetermined downlink path loss; and
uplink circuitry coupled between the base stations and the second group of dual-polarized antennas, wherein the uplink circuitry is configured to provide predetermined uplink path loss.

23. The wireless test system defined in claim 22, further comprising:
a plurality of radio-frequency duplexers, wherein the radio-frequency duplexers are coupled between the base stations and the downlink circuitry, and wherein the plurality of radio-frequency duplexers are coupled between the base stations and the uplink circuitry.

24. The wireless test system defined in claim 22, further comprising:
a plurality of radio-frequency isolators, wherein the radio-frequency isolators are coupled between the base stations and the downlink circuitry, and wherein the radio-frequency isolators are coupled between the base stations and the uplink circuitry.

25. The wireless test system defined in claim 21, further comprising:
a plurality of base station emulators;
downlink circuitry coupled between the base station emulators and the first group of dual-polarized antennas, wherein the downlink circuitry is configured to emulate a fading downlink channel; and
uplink circuitry coupled between the base station emulators and the second group of dual-polarized antennas, wherein the uplink circuitry is configured to emulate a fading uplink channel.
